(19) United States
(12) Patent Application Publication
(10) Pub. No.: US 2009/0145459 A1
(43) Pub. Date: Jun. 11, 2009

(54) HEAT-COMPRESSED ERODIBLE FOAM SUBSTRATE IMPREGNATED WITH AN ACTIVE AGENT

(75) Inventor: Denis Alfred Gonzales, Bruxelles (BE)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble company

(21) Appl. No.: 11/950,536

(22) Filed: Dec. 5, 2007

(51) Int. Cl. B08B 1/00; B08B 7/00

(52) U.S. Cl. 134/6; 15/104.93

(57) ABSTRACT

A cleaning implement comprising a heat-compressed erodible foam substrate impregnated with an active agent and substantially free of a chemical controlled release composition. The cleaning implement reduces the loss rate of the active agent and extends the life of the cleaning implement.

### FIELD OF THE INVENTION

The present invention relates to a cleaning implement having a heat-compressed erodible foam substrate impregnated with an active agent and substantially free of a chemical controlled release composition for longer lasting cleaning performance.

### BACKGROUND OF THE INVENTION

Use of an erodible foam, such as melamine-formaldehyde resin foam (“melamine foam”) for hard surface cleaning is well known. Cleaning implements of cut or molded melamine foam are popular for removing soils and stains from hard surfaces. Melamine foams are currently marketed in some countries under the tradename of Mr. Clean Magic Eraser™. Melamine foams, when wetted with an appropriate solvent, show excellent soil and stain removal in cleaning hard surfaces. Although melamine foam is generally effective in removing soils and stains from hard surfaces, consumers may find it difficult to remove certain kinds of tough stains with melamine foam, even after applying extra rubbing force. To improve the cleaning performance of melamine foam over tough stains, one may use a detergent composition along with the melamine foam to clean. The sponge and detergent can be provided separately or the sponge may be impregnated with the detergent. Consumers may still find it inconvenient to apply the detergent and then scrub. Further, sponges impregnated with detergents tend to release the active agents quickly, leading to significant loss of the active agent after the first several uses. In turn, reduced cleaning properties are observed as the active agent is used up. Also, when an active agent releases quickly in the first or second use, the high level of active agent may require extra rinsing. Loss of these active agents was controlled in the past by adding controlled release agents such as polymers, microcapsules, particulate porous carriers, or semi-permeable substrates to erodible foam substrates. Adding these control release systems may, however, increase costs and reduce manufacturing efficiencies. Thus, the need exists for a cleaning implement which is able to clean tough stains while maximizing the life of an erodible substrate and minimizing the loss of active agents.

### SUMMARY OF THE INVENTION

The present invention encompasses a cleaning implement comprising a heat-compressed erodible foam substrate impregnated with an active agent selected from the group consisting of surfactants, bleaching agents, limescale reducing agents, biocides, solvents, and mixtures thereof. The cleaning implement of the present invention is substantially free of a chemical controlled release composition.

The present invention further encompasses a method of cleaning a surface with the aforementioned cleaning implement.

It has now been surprisingly found that by combining an active agent with a heat-compressed erodible foam substrate of a cleaning implement, the loss of the active agent is minimized and the life of the cleaning implement is extended, even where the cleaning implement is substantially free of a chemical controlled release composition.

### BRIEF DESCRIPTION OF THE DRAWINGS

FIG. 1 is a perspective view of an embodiment of the cleaning implement herein with a heat-compressed erodible foam substrate and a second substrate.

FIG. 2 is a perspective view of another embodiment of the cleaning implement herein with three substrate layers in an oblique rectangular prism-like shape.

### DETAILED DESCRIPTION OF THE INVENTION

In accordance with the present invention, it has been found that heat-compressed erodible foams reduce the loss of active agents that are impregnated therein. Without wishing to be bound by any particular theory, it is believed that when a solvent such as water is in contact with an active agent, the active agent forms foaming layers within the pores of the heat-compressed erodible foam substrate. These foaming layers increase the surface tension of the active agents and make the erodible foam substrate more hydrophobic. Surprisingly, the rate of active agents escaping out of heat-compressed erodible foams is reduced, even where the erodible foam is substantially free of chemical compositions that control or delay the release of active ingredients. An amount of chemical composition that may be effective in controlling or delaying the release of active compositions from erodible foam substrates may be greater than about 5%, alternatively about 0.5% to about 5%, alternatively about 1% to about 5%, alternative about 2.5% to about 5%, by total weight of the substrate, the active, and the chemical controlled release composition.

### Cleaning Implement

The cleaning implement herein is an article of manufacture of any suitable shape, size, and/or volume suitable for removing spots and/or stains from surfaces. The cleaning implement herein is a heat-compressed erodible foam substrate impregnated with an active agent. “Erodible foam” herein means foam which crumbles into small particles and peels off by friction. A suitable erodible foam includes, but is not limited to, melamine foam, phenolic foam, etc. According to the present invention, the erodible foam has been heat-compressed. By “heat-compressed”, it is meant that the erodible foam has been subject to two distinct operations: a heating step and a compression step. One type of heat-compressed foam suitable for the present invention is disclosed in US Publication No. 2007/0061991, which is incorporated in its entirety by reference.

The heat compressed erodible foam substrate may be a commercially-available melamine foam substrate, e.g., Basotect™ from BASF that can be heat-compressed thereafter. In one embodiment, the heat-compressed erodible foam is an open-cell foam having a density in the range of from about 7 to about 50 kg/m³, alternatively from about 15 kg/m³ to about 40 kg/m³, alternatively from about 15 kg/m³ to about 30 kg/m³, alternatively from about 18 kg/m³ to about 25 kg/m³, alternatively about 20 kg/m³. The density size can be determined by DIN EN IS0 845. As used herein, “open-cell foam” means foam in which at least 50%, alternatively from about 60% to about 100%, alternatively from about 65% to about 99.9% of all the lamellae are open, determined according to DIN ISO 4590.

The cells can be shaped, for example, like compressed channels and can have an average pore diameter (number-average) in the range of from about 1 μm to about 400 μm, from about 50 μm to about 400 μm, from about 80 μm to about 250 μm, from about 80 μm to about 200 μm, from about 80 μm to about 150 μm, from about 80 μm to about 100 μm determined via evaluation of micrographs of sections. The pore size can be determined by utilizing a magnifying lens or optical microscope and counting the number of cells per a given length. This may be repeated at various locations of the foam for better accuracy. For example, the number of cells can be counted along a 1 inch length of the foam substrate in which the number of cells are expressed in PPI Pore per inch.

The cleaning implement can contain one or more additional substrates such as a second erodible foam substrate of a material different from the heat-compressed erodible foam substrate. Each additional substrate may have any thickness and volume appropriate for its intended use. In one embodiment, each additional substrate has a thickness of less than about 30 mm, or from about 2 mm to about 15 mm, or from about 5 mm to about 10 mm. “Thickness” means the length in mm of the side having the smallest extension compared to other sides of the substrate (e.g. the height of the substrate) when the substrate is not deformed or pressed by a user. The height of a heat-compressed erodible foam substrate compared to the same substrate that has not been heat-compressed may be about 3:1, alternatively about 2:1, alternatively about 2.5:1.5.

Such additional substrates may be attached directly to the heat-compressed erodible foam substrate or to another additional substrate. The density size can be determined by DIN EN IS0 845.

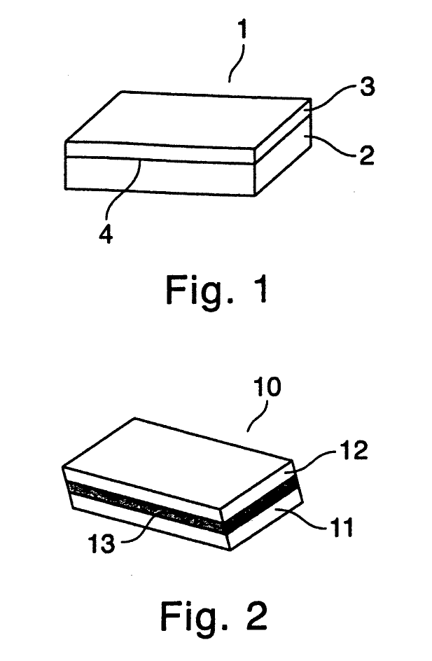

FIG. 1 shows a cleaning implement 1 with a first substrate 2 made of heat compressed foam and a second substrate 3 attached to the first substrate 2 by an adhesive attachment 4. Useful liquid-impermeable adhesive materials include PM17 and LA hotmelt from Savare (Milano, Italy), Propel™, SolarCure™, Optimelt™, Clarity™, Fullback™ hotmelts from Fuller (Minnesota, USA), Fulaprene, Bondseal solvent adhesive from Fuller, and Rakol™, AirSperse™, LiquiLoc™, Casemate™, and water-based adhesives from Fuller. The first substrate 2 has an active agent therein. In one embodiment, the active agent is injected into the central region of the first substrate 2.

The second substrate 3 may perform a function different from the first substrate 2, for instance, to serve as an absorbency substrate, a wiping substrate, a supporting substrate, a scrubbing substrate, or a handle substrate. Where the second substrate 3 is designed as a handle substrate, controlled release system will be loaded into the first substrate 2 and expelled from the first substrate 2 in use. Hand contact with the active agent can be minimized by holding only the second substrate 3. Preferably, an indicium such as a different color, a marking, a word, etc. is included to guide a user to hold the second substrate 3 and contact the surface to be cleaned with the first substrate 2.

Where the second substrate 3 is not a heat-compressed erodible foam substrate, the second substrate 3 can be made from a cellulose foam sponge, a naturally occurring sponge, a nonwoven, or a foam of a polymer comprising a monomer selected from the group consisting of a urethane, a propylene, an ethylene, a vinyl acetate, an ester, an acrylate, an ether and a mixture thereof, such as polyurethane, polypropylene, polyethylene, polyvinyl acetate, polyester, polyurethane-ether, polyurethane-ester, polyethylene-vinylacetate, polyethylene-methacrylate, etc. The second substrate 3 may be a hydrophilic ester polyurethane foam, such as Cellulex™ from Foamex L. P., capable of absorbing liquids, without swelling appreciably. See U.S. Pat. No. 6,756,416.

The second substrate 3 may be more hydrophobic than the heat-compressed erodible foam and used as a handle substrate. Exemplary hydrophobic substrates include closed-cell foam of a polymer having a monomer selected from the group consisting of a urethane, a propylene, an ethylene, a butadiene, a styrene, vinyl acetate, a silicon, an ester, an acrylate, an ether, cellulose acetate, styrene, silicon, natural latex, rubber, vinylchloride, fluoroethylene, and mixtures thereof, available as Plastazote™, Evazote™, Supazote™, Propazote™ from Zotefoams pic (Croydon, UK) and FR, FM, CN or SD foam grade made with a significant fraction of hydrophobic polymer/materials.

FIG. 2 shows another embodiment of a cleaning implement 10 with three layers of substrate in a sandwiched configuration having a rectangular shape, wherein at least one of the two outside substrates 11 and 12 is a heat-compressed erodible foam substrate. The middle substrate 13 is a semi-permeable substrate. In this embodiment, active agent is released only from substrate 11. Substrate 12 can be used as a handle substrate. Suitable semi-permeable substrates herein include flexible liquid-impermeable films having open pores, such as polyolephin films based on polyethylene and polypropylene, polyester, polyamide, polyester-ether copolymer, polyamide-ether, and Teflon™ films. These films typically have a basis weight of 1-250 g/m², or 2-60 g/m². Semi-permeable substrates are commercially available from Clopay, RKW, Mitsui, Tacolin, 3M, Dupont, and International Plastic. Pore size and pore density (number of pores per square meter of films) can be adjusted to tailor the release kinetics of the active agent through the pores. Typically, the pore size is from about 100 μm to about 10 mm, or from about 0.5 mm to about 2 mm, and the pore density is from about 100 pores/m² to about 500,000 pores/m², or from about 3000 pores/m² to about 30,000 pores/m². Microporous film is generally defined by their water vapor permeability (WVTR) as measured, for instance by PERMATRAN-W™ Model 398 from Mocon (e.g.: ASTM Standard E-398). Suitable microporous film has a WVTR of from about 100 to about 25,000 g/m²/day, or from about 2,000 to about 6,000 g/m²/day. Other suitable semi-permeable film is high liquid-barrier nonwoven containing a high fraction of fibers made of hydrophobic material. Typical high liquid-barrier nonwoven has a basis weight of 1-500 g/m², or from 10-150 g/m², or from 40-80 g/m². Preferable high liquid-barrier nonwoven is made of 100% of polypropylene fibers and formed by spunbond (S), meltblown (M), and combinations thereof, such as SMS, SMMS, etc. High liquid-barrier nonwoven is commercially available from BBA, PGI, Freudenberg, Alsthom, and Jacobholm.

Where the cleaning implement herein includes more than one substrate, the heat-compressed erodible foam substrate, the semi-permeable substrate and the additional substrates may be attached by any attachment suitable for joining the substrates and films. The attachment may be either permanent (wherein the two substrates cannot be separated without inflicting substantial damage to the substrates) or temporary (wherein the two substrates may be separated without inflicting substantial damage to the substrates) as desired. Suitable permanent attachments include permanent adhesive, foam flame lamination, sewing or needle-punching the substrates and/or films together, and a combination thereof. The substrates or films can also be joined together by a permanent adhesive. Useful adhesives include vinylic emulsions, such as those based on vinyl acetate or other vinyl esters, such as homopolymers and copolymers of ethylene and/or acrylic monomers (vinyl acrylics); homopolymers or copolymers of acrylic emulsions; a cross-linked adhesive including those created by including a reactive co-monomer (e.g., a monomer containing carboxyl, hydroxyl, epoxy, amide, isocyanate, etc. functionality) which are capable of cross-linking the polymer themselves (e.g. carboxyl groups reacting with hydroxyl, epoxy or isocyanate groups) or by reaction with an external cross-linker (e.g. urea-formaldehyde resin, isocyanates, polyols, epoxides, amines and metal salts, especially zinc). The adhesives herein can also include limited quantities of tackifying resins to improve adhesion, such as the addition of hydrogenated rosin ester tackifier to vinyl acetate/ethylene copolymer latex. See also the adhesive compositions in U.S. Pat. No. 5,969,025. Adhesives can be applied by, for example, spray coating to give a discontinuous attachment, curtain coating, roll coating, slot coating or lick coating to give a continuous attachment.

A suitable temporary attachment includes a weak adhesive, such as low peel force adhesive, repositionable adhesive, such as “PSA” (Pressure Sensitive Adhesive) having permanent tacks (some also called softgel or hydrogel adhesive, such as Dispomelt™ available from National Starch); a hook-and-loop fastening system (e.g. Velco™); a water-based, water-soluble coating or adhesive; an interlocking substrate shape that provides stability and an interlocking fit, and a combination thereof.

Suitable shapes of the cleaning implements herein may be selected from the group consisting of a cubic shape, a rectangular shape, a pyramidal shape, a cylindrical shape, a conical shape, an oblique rectangular prism shape, a cuboid shape, a tetrahedron shape, a sphere shape, a globular shape, and an ellipsoid shape. “Oblique rectangular prism shape” herein means a voluminous body having six walls, wherein three pairs of parallel and equally shaped and sized walls exist and wherein one pair of walls are in the shape of a parallelogram and the remaining two pairs of walls are of rectangular shape.

### Active Agent

The cleaning implement herein may contain an active agent selected among a surfactant, a bleaching agent, a limescale reducing agent, a biocide, a solvent and a mixture thereof. In one embodiment, the active agent may have an HLB greater than about 5, alternatively greater than about 8 to about 14, alternatively greater than about 12. In another embodiment, the active agent may be present in free form in an amount from about 5% to about 20%, or from about 10% to about 15% by weight of the active agent. An active agent in free form means that the active agent is supplied to the cleaning implement in its neat form whose release from the cleaning implement is not purposefully controlled, delayed, or sustained.

Surfactants that are suitable for the present invention can be nonionic, anionic, cationic, amphoteric and/or a zwitterionic surfactant. Suitable nonionic surfactants include alkoxylated fatty alcohol having the formula of RO(EO)e(PO)pH, where R is a hydrocarbon chain of from 2 to 24 carbon atoms, EO is ethylene oxide and PO is propylene oxide, e and p respectively representing the average degree of ethoxylation and propoxylation, are independently from 0 to 24, or R is a straight alkyl chain having from 6 to 22 carbon atoms, e is 5-12 and p is 0 (e.g. Lutensol™). Suitable cationic surfactants herein include derivatives of quaternary ammonium, phosphonium, imidazolium and sulfonium compounds. Preferred cationic surfactants herein are trimethyl quaternary ammonium compounds. Suitable amphoteric surfactants herein include amine oxides, betaine or ammonium sulfate or ammonium carboxylate, having the following formula R₁R₂R₃NO, R₁R₂R₃NR₄SO₄ or R₁R₂R₃NR₄CO₂ wherein each of R₁, R₂ and R₃ is independently a saturated substituted or unsubstituted, linear or branched alkyl groups of from 1 to 30, or from 8 to 18 carbon atoms, except for R₄ which preferably contain 3 saturated carbons. Preferred amine oxides herein are for instance natural blend C₈-C₁₀ amine oxides, and C₂-C₆ amine oxides, such as cetyl dimethyl amine oxide. Preferred betaine herein is cocamidopropyl betaine and lauramidopropyl betaine. Suitable anionic surfactants include alkyl diphenyl ether sulphonate and alkyl carboxylate. Other suitable anionic surfactants herein include water soluble salts or acids of the formula ROSO₃M wherein R is preferably a C₁₀-C₂₄ hydrocarbyl, or C₁₂-C₁₈ alkyl or hydroxyalkyl, and M is H or a cation, such as sodium, potassium, lithium, or ammonium or substituted ammonium. Other suitable anionic surfactants include soap salts, C₉-C₂₀ linear alkylbenzenesulfonates, C₈-C₂₂ primary or secondary alkylsulfonates, sulfonated polycarboxylic acids, C₈-C₂₄ alkylpolyglycolethersulfates (containing up to 10 moles of ethylene oxide); alkyl ester sulfonates, sulfates of alkylpolysaccharides, alkyl polyethoxy carboxylates, such as those of the formula RO(CH₂CH₂O)ₖCH₂COO-M⁺ wherein R is a C₈-C₂₂ alkyl, k is an integer from 0 to 10, and M is a soluble salt-forming cation. Resin acids and hydrogenated resin acids are also suitable. Further examples are given in. “Surface Active Agents and Detergents” (Vol. I and II by Schwartz, Perry and Berch). A variety of such surfactants are also generally disclosed in U.S. Pat. No. 3,929,678.

Bleaching agents herein may be selected from a hydrogen peroxide source, a preformed peroxycarboxylic acid, a hypohalite bleach source, and a mixture thereof. Hydrogen peroxide sources herein include persulfate, dipersulphate, persulfuric acid, percarbonate, perborate, metal peroxide, perphosphate, persilicate, urea peroxyhydrate and a mixture thereof. Preformed peroxycarboxylic acids herein include those containing one, two or more peroxy groups, and can be aliphatic or aromatic. When the organic percarboxylic acid is aliphatic, the unsubstituted acid suitably has the linear formula: HO—O—C(O)—(CH₂)ₙ—Y, wherein Y is H, CH₃, CH₂Cl, COOH or C(O)OOH; n is an integer of 1-20. Branched analogs are also acceptable. When the organic percarboxylic acid is aromatic, the unsubstituted acid suitably has formula: HO—O—C(O)—C₆H₄—Y wherein Y is hydrogen, alkyl, alkyhalogen, halogen, —COOH or —C(O)OOH. Monoperoxycarboxylic acids useful as oxygen bleach herein are further illustrated by alkyl percarboxylic acids and aryl percarboxylic acids such as peroxybenzoic acid and ring-substituted peroxybenzoic acids, e.g., peroxy-α-naphthoic acid; aliphatic, substituted aliphatic and arylalkyl monoperoxy acids such as peroxylauric acid, peroxystearic acid, and N,N-phthaloylaminoperoxycaproic acid (PAP); and 6-octylamino-6-oxo-peroxyhexanoic acid. Peracids can be used in acid form or any suitable salt with a bleach-stable cation. Suitable hypohalite bleaching agents herein include those that form positive halide ions and/or hypohalite ions, and bleaching agents that are organic based sources of halides, such as chloroisocyanurates. Suitable hypohalite bleaching agents herein include alkali metal and alkaline earth metal hypochlotite, hypobromite, hypoiodite, chlorinated trisodium phosphate dodecahydrate, potassium and sodium dichloroisocyanurates, potassium and sodium trichlorocyanurates, N-chloroimides, N-chloroamides, N-chloroamines and chlorohydantoins.

Limescale reducing agents herein include, but are not limited to, acids and chelating agents. Exemplary acids useful herein include hydrochloric acid, phosphoric acid, sulfuric acid, sulfamic acid, acetic acid, hydroxyacetic acid, citric acid, benzoic acid, tartaric acid, formic acid and mixtures thereof. A mixture of organic and inorganic acid is preferred. Chelating agents useful herein can include, but are not limited to, carboxylates, phosphates, phosphonates, polyfunctionally-substituted aromatic compounds, polyamines, biodegradable compounds, the alkali metal, ammonium or substituted ammonium salts or complexes of these chelating agents, and mixtures thereof. Further examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

Biocide means any known ingredient having the ability of reducing or even eliminating by killing or removing the micro-organisms existing on a surface, such as those described in U.S. Pat. No. 6,613,728. Biocide useful herein includes a quaternary surface active compound, a guanidine, an alcohol, a glycerol, a phenolic compound, a heavy metal salt, an inorganic and organic acid, a halogen, a halogen-containing compound, a dye, an essential oil, an oxidizing compound, an adsorbent, a fungicide, an algaecide and a mixture thereof. Exemplary quaternary surface active compounds include benzalkonium chloride, benzethonium chloride, cetyl pyridinium chloride, sodium tetradecyl sulfate, sichlorobenzalkonium chloride, methylbenzethonium chloride, cetyl dimethyl ethyl ammonium bromide. Exemplary guanidines include chlorohexidine hydrochloride, chlorohexidine gluconate, dodecylguanidine hydrochloride, polyhexmethylenebiguanidine hydrochloride, and 6-acetoxy-2,4-dimethylmetadioxane. Exemplary alcohols include methanol, ethanol, propanol, isopropanol, etc. Exemplary phenolic compounds include cresol, resolcinols and related compounds, phenol; substituted phenols—cresols, meta-cresylacetate, creosote, quaiacol, resorcinol, hexylresorcinol, pyrogallol, thymol, thymol iodide, picric acid, chlorinated phenols—dichlorophene, hexachlorophene, tars. Exemplary halogens and halogen-containing compounds include iodine and iodoform. Exemplary oxidizing agents include peroxide, sodium perporate, potassium permanganate, zinc permanganate, potassium chlorate. Exemplary heavy metal salts include mercuric chloride, miscellaneous ionizable mercuric salts, organic mercurials, silver nitrate, silver lactate, silver picrate, silver proteins, silver halides, zinc oxide, zinc stearate, copper sulfate and organic tin derivatives. Exemplary dyes include azo dyes, acridene dyes, fluorescein dyes, phenolphthalein dyes and triphenylmethane dyes. Exemplary inorganic and organic acids include hydrochloric acid, sulfuric acid, nitric acid, citric acid, sorbic acid, acetic acid, boric acid, formic acid, maleic acid, adipic acid, lactic acid, malic acid, malonic acid, glycolic acid, and mixtures thereof. Exemplary essential oils are thyme oil, clove oil, cinnamon oil, geranium oil, eucalyptus oil, peppermint oil, citronella oil, ajowan oil, mint oil or mixtures thereof. Other useful biocide herein includes furan derivatives, nitrofurantoin, sulfur, sulfur dioxide, ichthamol, chrysarobin, anthralin, betanaphthol, balsams, volatile oils, chlorophyl.

Biocides useful herein also include fungicides and algaecides which act against molds and mildew. Removal of algae and fungi from hard surfaces is difficult. Moreover, fungi and algae reappear promptly if not completely removed or inhibited. Suitable fungicides and algaecides include metal salts, such as zinc sulfate, zinc acetate, zinc bromide, zinc chloride, zinc iodide, zinc nitrate, zinc bromate and zinc chlorate, cooper halide, copper sulfate, organic tin derivatives, water-insoluble or partially water-soluble fungicides and algaecides, such as diiodomethyl p-tolyl sulfone, N-(trichloromethyl thio)phthalimide, N,N-dimethyl-N′-phenyl N′-(fluorodichloromethyl thio)sulphamide, 2-(thiocyanomethylthio)benzothiazole/methylene bis(thiocyanate), 3-iodo-2-propynyl butyl carbamate, etc., all available from ALDRICH chemical. Above biocides are optionally mixed with concentrated acids, such as acetic acid, formic, propionic, n-butanoic, n-pentanoic, trimethylacetic, n-hexanoic, lactic, methoxyacetic, cyanoacetic, chloroacetic, citric, partaric, etc.

The active agent may be a solvent having a good dissolving ability for greasy stains. Solvents useful herein include those which are at least partially water-miscible, such as alcohols, ethers, such as diethylene glycol diethylether, diethylene glycol dimethylether, propylene glycol dimethylether, propylene glycol monomethylether, propylene glycol monoethylether, propylene glycol monopropylether, propylene glycol monobutylether, ethylene glycol monobutylether, dipropylene glycol monomethylether, dipropylene glycol monopropyl ether, dipropylene glycol monobutyl ether, diethyleneglycol monobutylether, lower esters of monoalkylethers of ethylene glycol or propylene glycol, such as propylene glycol monomethyl ether acetate, N-methyl pyrolidone and tetrahydrofuran. Mixtures of several solvents can also be used.

### Packaging Means

The cleaning implement herein may be combined in an article of manufacture with a packaging means known for packaging cleaning implements. Particularly suitable packaging means herein can be paper bags, plastic bags, plastic bins, cartons, carton boxes, flow wraps, plastic wraps, and paper wraps, and the like and combinations thereof. Multiple uses of the cleaning implement may be packed together.

### Method of Cleaning a Hard Surface

The present invention encompasses a method of cleaning a surface by rubbing a cleaning implement herein against a hard surface. “Cleaning” means removing spots and/or stains from surfaces. Suitable surfaces include tiles, walls, floors, sanitary fittings such as sinks, showers, shower curtains, wash basins, toilets, household appliances including, but not limited to, refrigerators, freezers, washing machines, automatic dryers, ovens, microwave ovens, and dishwashers. The method of cleaning a surface may additionally include the step of wetting the cleaning implement with an appropriate solvent, such as tap water, prior to bringing the cleaning implement into contact with said hard surface.

The present invention is further illustrated by the following non-limiting example.

### EXAMPLE 1

Example 1 tests four different erodible foam substrates, as specified in Table 1, for the number of hand compressions necessary to release about 200 ppm of Lutensol XL 10™ (hereinafter “Lutensol”). It is believed that no significant cleaning benefit is observed after about 200 ppm of Lutensol is released from the substrate. For embodiments in which the erodible foam substrate is non-compressed, a sheet of Basotect® melamine (from BASF) having a thickness of about 23 to 29 mm is utilized. For embodiments in which the erodible foam substrate is heat-compressed, a sheet of Basotect® melamine is heat-compressed so that the final thickness is halved when compared to the thickness of the starting melamine. For example, if a starting thickness is about 38 mm, final thickness may be about 19 mm. Heat-compression can be achieved by placing the melamine sheet in a commercially available metal plate press using a compression factor of about 2:1 and applying heat at 270° C., while maintaining compression of the sheet, for typically 3 minutes. If necessary, lamination with additional layers is accomplished after heat-compression is completed. After heat-compression and lamination, if necessary, the melamine sheet is cut into 122×65 mm rectangular pieces with thickness accordingly to process of heat-compression. Lutensol is injected into the central region of the melamine with a dosing syringe having a metallic needle.

In order to evaluate the release of the Lutensol from the product, the erodible foam substrate is placed under tap water running at a rate of about 0.5 L/12 sec (=7 L/min) at 23° C. for about 5 seconds and then hand squeeze. The experiment should be done by a trained individual to ensure reproducibility of results even if final results are the average of repeated experiments. Collect squeezed out material for analysis. This rinse and squeeze cycle is repeated to collect material at the 1st, 5th, 10th, 15th, 20th, 25th, 30th, 35th, 40th, 45th, and 50th cycles.

TABLE 1

| | | | Number of squeezes |
|---|---|---|---|
| | | | to exhaust < 200 ppm |
| Sample | Substrate | Location of active | of Lutensol |
| A1 | Melamine (29 mm) | <0.2 g Lutensol dispersed uniformly | 3 to less than 5 |
| | | on surface | |
| A2 | | 0.8 g Lutensol dispersed uniformly | 3 |
| | | on surface | |
| A3 | | 0.8 g Lutensol injected in center | 10 to 12 |
| B1 | Heat-compressed | 0.8 g Lutensol dispersed uniformly | 5 |
| | melamine (19 mm) | on surface | |
| B2 | | 0.8 g Lutensol injected in center | 20 to 23 |
| C | Melamine (23 mm | 0.8 g Lutensol dispersed uniformly | 5 |
| | thick) with semi | at the interface of the melamine and | |
| | permeable substrate | the semi-permeable substrate | |
| | (6 mm thick) | | |
| D | Heat-compressed | 0.8 g Lutensol dispersed uniformly | 10 |
| | melamine (19 mm | at the interface of the melamine and | |
| | thick) with semi | the semi-permeable substrate | |
| | permeable substrate | | |
| | (6 mm thick) | | |

Surprisingly, Table 1 demonstrates that the active agents of the present invention are retained 100% better in Samples B and D, heat-compressed erodible foam substrates, than Samples A and C, non heat-compressed erodible foam substrates. This is surprising given that it is generally known that water and air flow through erodible foam substrates are not meaningfully affected by cell size (i.e. whether the substrate has been heat-compressed or not).

Table 1 also demonstrates that the injected location of Lutensol has an impact on the rate of loss of the active. Specifically, if Lutensol is injected at the surface of the melamine foam, its exhaustion is less than 3 uses. If Lutensol is injected in the centeral region of the melamine foam, the number of usages of the substrate more than doubled.

### EXAMPLE 2

Example 2 tests a non-heat compressed erodible foam substrate for the number of hand compressions necessary to release about 200 ppm of Lutensol. In this example, Lutensol is mixed with PEG 9000, a chemical controlled release agent. Specifically, 0.8 g of a formulation containing 10% PEG 9000 and 90% Lutensol is injected into the central region of the erodible foam substrate with a dosing syringe having a metallic needle.

In order to evaluate the release of the Lutensol from the product, the erodible foam substrate is placed under tap water running at a rate of about 0.5 L/12 sec (=7 L/min) at 23° C. for about 5 seconds and then hand squeeze. The experiment should be done by a trained individual to ensure reproducibility of results even if final results are the average of repeated experiments. Squeezed out material is collected for analysis. This rinse and squeeze cycle is repeated to collect material at the 1st, 5th, 10th, 15th, 20th, 25th, 30th, 35th, 40th, 45th, and 50th cycles.

TABLE 2

| | | | Number of squeezes |
|---|---|---|---|
| | | | to exhaust < 200 ppm |
| Sample | Substrate | Location of active | of Lutensol |
| E | Melamine (29 mm) | 0.72 g Lutensol | 25 to 30 |
| | | and 0.08 g PEG | |
| | | 9000 injected in | |
| | | center | |

Surprisingly, Table 2 demonstrates that Sample E, a melamine substrate with a chemical controlled release agent, performs similarly to Sample B2 in Table 1, a heat-compressed melamine having no chemical controlled release agent.

The dimensions and values disclosed herein are not to be understood as being strictly limited to the exact numerical values recited. Instead, unless otherwise specified, each such is not to be construed as an admission that it is prior art with respect to the dimension is intended to mean both the recited value and a functionally equivalent range surrounding that value. For example, a value disclosed as “10%” is intended to mean “about 10%”. Further, all percentages are intended to mean weight percent and all temperatures herein are in degree Celsius (° C.), unless otherwise indicated.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments herein have been illustrated and described, it would be obvious to those skilled in the art that various other changes and modifications can be made without departing from the spirit and scope of the invention. It is, therefore, intended to cover in the appended claims all such changes and modifications that are within the scope of this invention.

What is claimed is:

1. A cleaning implement comprising
a. a heat-compressed erodible foam substrate; and
b. an active agent impregnated in said heat compressed erodible foam substrate wherein said active agent is selected from the group consisting of surfactants, bleaching agents, limescale reducing agents, biocides, solvents, and mixtures thereof;
wherein said cleaning implement is substantially free of a chemical controlled release composition.

2. The cleaning implement of claim 1, wherein said heat-compressed erodible foam has an average pore size of about 50 μm to about 250 μm.

3. The cleaning implement of claim 1, wherein said heat-compressed erodible foam has an average pore size of about 80 microns to about 150 microns.

4. The cleaning implement of claim 1, wherein said heat-compressed erodible foam substrate has a density of about 15 kg/m³ to about 40 kg/m³.

5. The cleaning implement of claim 1, wherein said heat-compressed erodible foam substrate has a density of about 18 kg/m³ to about 25 kg/m³.

6. The cleaning implement of claim 1, wherein said heat-compressed erodible foam substrate has a density of about 20 kg/m³.

7. The cleaning implement of claim 1, wherein said heat-compressed erodible foam substrate is a heat-compressed melamine foam substrate.

8. The cleaning implement of claim 1, further comprising a closed-cell foam substrate attached to said heat-compressed erodible foam substrate by an adhesive attachment.

9. The cleaning implement of claim 1, wherein said cleaning implement comprises three layers of substrate in a sandwiched configuration, wherein said heat-compressed erodible foam substrate is positioned as at least one of the outside layers attached to a semi-permeable middle layer by adhesion.

10. The cleaning implement of claim 1, wherein said active agent is impregnated in the central region of said heat-compressed erodible foam substrate.

11. The cleaning implement of claim 1, wherein said active agent is present in free form in an amount from about 5% to about 20% by weight of said active aspect.

12. A method of cleaning a surface comprising the steps of:
a. providing a cleaning implement comprising a heat-compressed erodible foam substrate having an active agent impregnated in said heat-compressed erodible foam substrate wherein said active agent is selected from the group consisting of surfactants, bleaching agents, limescale reducing agents, biocides, solvents, and mixtures thereof, and wherein said cleaning implement is substantially free of a chemical controlled release composition; and
b. rubbing said cleaning implement against a surface.

13. The method of claim 12 further comprising the step of wetting said cleaning implement with an appropriate solvent prior to step b.
